(19) United States
(12) Patent Application Publication
(10) Pub. No.: US 2010/0064529 A1
(43) Pub. Date: Mar. 18, 2010

(54) METHOD AND APPARATUS FOR ANVIL PRUNER AND LOPPER WITH SHOCK ABSORBING FEATURE

(75) Inventors: Linn E. Nelson, Portland, OR (US); Karl H. Zeller, Portland, OR (US)

Correspondence Address: PATENTTM.US, P. O. BOX 82788, PORTLAND, OR, 97282-0788, US

(73) Assignee: BARNEL INTERNATIONAL, INC., Portland, OR (US)

(21) Appl. No.: 12/211,751

(22) Filed: Sep. 16, 2008

(51) Int. Cl. B26B 17/00

(52) U.S. Cl. 30/275.4

(57) ABSTRACT

A shock absorbing anvil pruner/lopper comprises a cutting blade and a shock absorbing anvil member with a compound action tang. The anvil member includes a liner member for engagement with the blade and a shock absorber in relation to the liner member, whereupon on engagement of the blade with the liner member during a cutting operation, the shock absorber will compress or otherwise absorb some of the force, providing for less physical shock being transmitted to the user through the pruner/lopper handles.

### BACKGROUND OF THE INVENTION

This invention relates to tools, and more particularly to anvil type pruners and loppers with shock absorbing features.

Anvil type pruners and loppers, where a cutting blade is moved down against an anvil portion with a branch being cut therebetween, are highly effective.

However, the impact of the blade to the anvil, especially when cutting hard or thick branches or the like, can result in a jarring physical shock, which is transmitted to the user's hands and arms. Such physical shock can lead to user fatigue or increase the likelihood of repetitive motion injuries and carpal tunnel syndrome.

### SUMMARY OF THE INVENTION

In accordance with the invention, an anvil type pruner/lopper is provided with a shock absorbing feature to dampen the physical shock between the blade and anvil when completing a cut.

Accordingly, it is an object of the present invention to provide an improved anvil pruner/lopper which promotes clean cuts.

It is a further object of the present invention to provide an improved anvil pruner/lopper with shock absorbing features built in along with promoting clean cuts.

It is yet another object of the present invention to provide an improved anvil pruner/lopper with a shock absorber provided to the anvil portion for reduction of physical shock from cutting operations.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a partial side view of an anvil type pruner/lopper with shock absorbing features;

FIG. 2 is a sectional view thereof taken along line 2-2 of FIG. 1;

FIG. 3 is a view in accordance with FIG. 2, illustrating shock absorbing effect;

FIG. 4 is a perspective view of the anvil portion of the pruner/lopper of FIG. 1;

FIG. 5 is an exploded view of the anvil portion of FIG. 4, illustrating the components thereof;

FIG. 6 is a perspective view of an alternate embodiment of the anvil portion of the pruner/lopper; and

FIG. 7 is an exploded view of the anvil portion of FIG. 6, illustrating the components thereof.

### DETAILED DESCRIPTION

The system according to a preferred embodiment of the present invention comprises an anvil pruner/lopper having a shock absorbing feature.

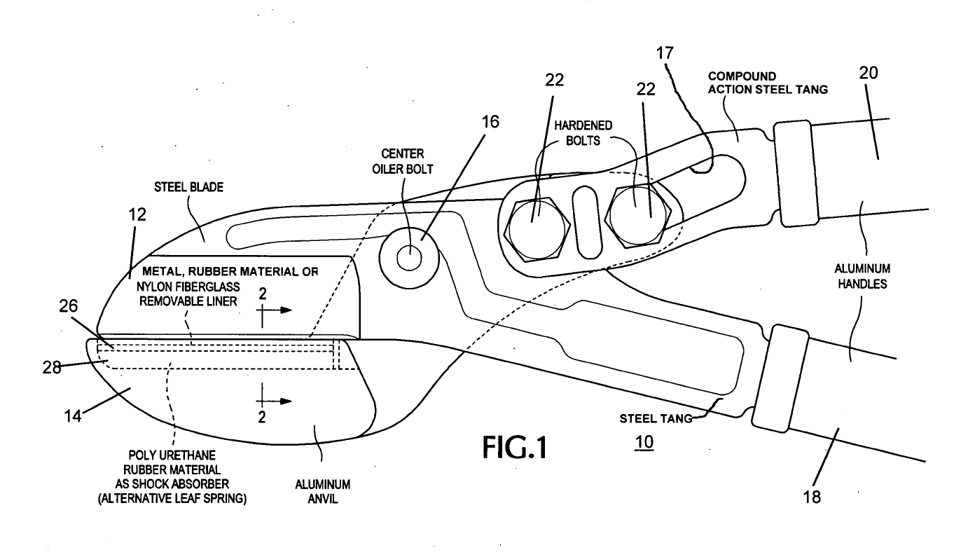

Referring to FIG. 1, a partial side view of an anvil type pruner/lopper 10 with shock absorbing features, the pruner/lopper comprises a blade portion 12 and anvil portion 14, which cooperate via pivot 16 to open and close relative to one another by pivoting around the center axis of pivot 16. Blade portion 12 mounts to a handle 18, while anvil portion 14 mounts to handle 20, for example, by use of bolts 22, 24 for the case of portion 14. The bolts cooperate with portion 14, portion 12 and a slot 17 in the steel tang inserted to handle 20 to provide a compound action for enabling cuts with less strength required of the user. The compound function creates greater travel of the handle without measurable blade movement that ultimately equates to increased force at the jaws of the pruner/lopper without the user having to exert more force. The compound action tang that pivots on the two bolts adds to the strength of the overall tool and reduces field breakage. The handles suitably extend a sufficient length to provide an operative pruner/lopper functioning. An anvil cutting base 26 with shock absorbing portion 28 mount within anvil portion 14, whereby cutting base 26 is positioned to contact with blade portion 12 when the pruner/lopper is in a closed position (as illustrated in FIG. 1).

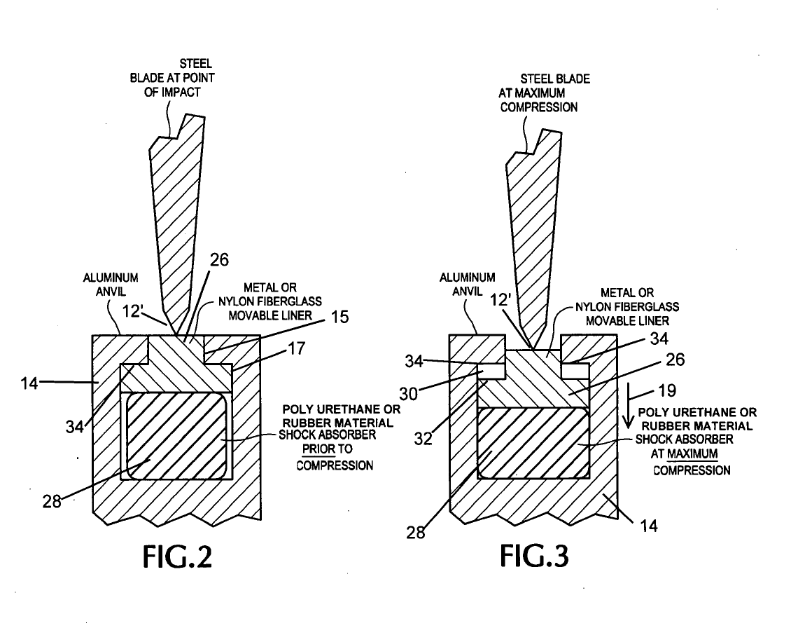

Referring now to FIG. 2, a sectional view taken along line 2-2 of FIG. 1, with the pruner/lopper in a closed or cutting configuration, the cutting blade surface 12′ of blade portion 12 meets and contacts a corresponding surface of anvil cutting base 26. Below cutting base 26, a shock absorbing member 28 is provided. Anvil portion 14 is formed so as to provide a containment region to hold cutting base and shock absorbing member 28 in relative positions to each other and to the anvil portion.

The anvil portion has an interior region that receives anvil cutting base and shock absorbing member 28 therein. In the illustrated embodiment, anvil portion 14 has a central opening slot 15 of a first width, with an interior region 17 of greater width. A stepped profile is provided by an upper ledge 34 of the anvil portion 14 and anvil cutting base 26 has a corresponding profile portion 32 to interact therewith to define an upper extension limit to the cutting base relative to the interior profile. In the illustrated embodiment, the profiles are of substantially right angle edges, but other profiles may be employed, whether with sharply defined edges or smooth or curved edges.

Referring now to FIG. 3, a view in accordance with FIG. 2, illustrating shock absorbing effect, as the pruner/lopper handles are moved further to a fully closed or cutting position, blade portion 12′ will press in the direction of arrow 19 against anvil cutting base 26. Shock absorbing member 28 will thereby compress somewhat as illustrated at 28′ whereby anvil cutting base 26 may move inwardly of the anvil base, providing a shock absorbing function while still enabling cutting action between the blade 12′ and anvil cutting base 26. A space 30 may suitably appear between the upper surface 32 of the anvil cutting base and the upper ledge 34 of the anvil portion 14. Upon release of the pressure of blade 12′ against anvil cutting base 26, the shock absorbing member 28 will return to substantially its original configuration (as in FIG. 2), causing the anvil cutting base 26 profile portion 32 to move back into it engaging position with anvil portion 14 upper ledge 34. Shock absorbing member 28 is a replaceable part.

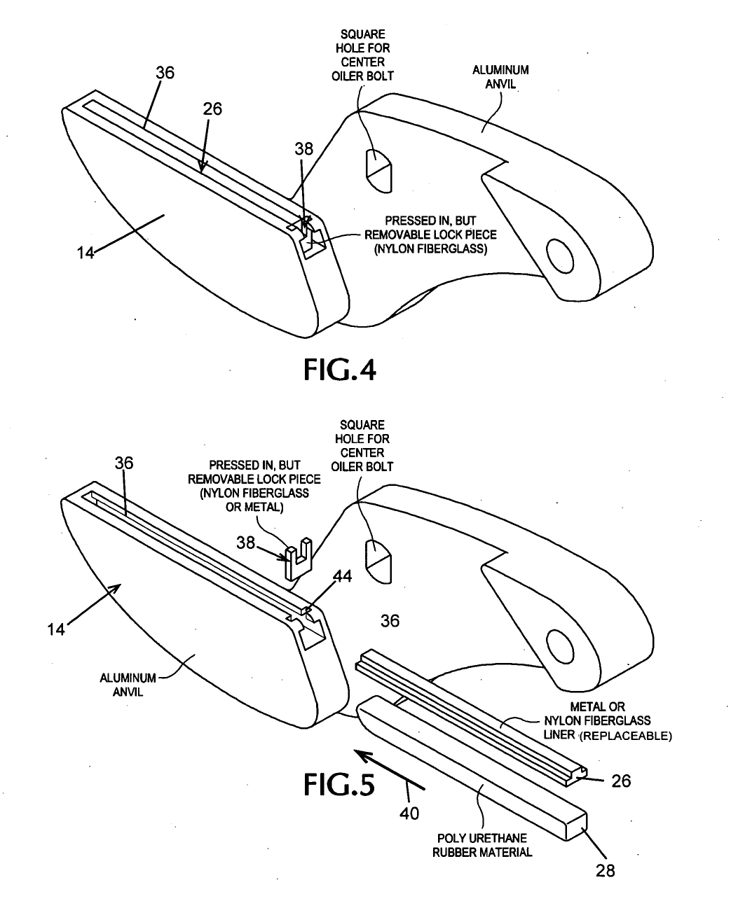

Referring to FIGS. 4 and 5, a perspective view of a first embodiment of the anvil portion of the pruner/lopper of FIG. 1 and an exploded perspective view thereof, the anvil portion 14 includes a longitudinal slot 36 formed therein, having length sufficient to correspond at least to the length of the corresponding blade portion 12′. Interior of the anvil portion, the slot 36 is made of greater width than the width along the face of anvil portion 14, so as to provide space to accommodate placement of anvil cutting base 26 and shock absorbing member 28 therein.

Anvil cutting base 26 and shock absorbing member 28 suitably insert into the space define in anvil portion 14, in the direction of arrow 40, and are secured therein against unintended removal by key 38 which is inserted into a corresponding key slot 44 in anvil portion 14, to block removal thereof.

Thus, assembly is accomplished by inserting cutting base 26 and shock absorbing member 28 into the opening of anvil portion 14, followed by insertion of key 38. By reverse procedure, the cutting base and shock absorbing members can be removed for repair or replacement.

In a particular embodiment, blade portion 12 is made of steel, anvil portion 14 is of aluminum, pivot 16 comprises a center oiler bolt and handles 18, 20 comprises aluminum handle members. Bolts 22, 24 are hardened bolts or other suitable fasteners that create a compound action in conjunction with the configuration and shape of the other portions of the device to enable reduction in the amount of strength required to complete a cut. The pivot 16 may comprise, for example, a center oiler bolt by Barnel International, Inc., Portland, Oreg. US, which includes an interior lubrication reservoir with lubrication channels to provide ongoing lubrication to the pivoting region and elements during use. The reservoir includes a refilling capability to replenish the lubrication as desired. Anvil cutting base 26 comprises nylon fiberglass and shock absorbing member 28 comprises poly urethane rubber material. The cutting base 26 may also be a metal member, or of other composition to provide an engagement surface to meet with the blade. Alternatively, shock absorbing member may be a leaf spring or other mechanical spring mechanism. Key 38 (which is optional) and may comprise nylon fiberglass, is sized to provide a friction fit to remain in place in absence of intentional removal forces being applied thereto.

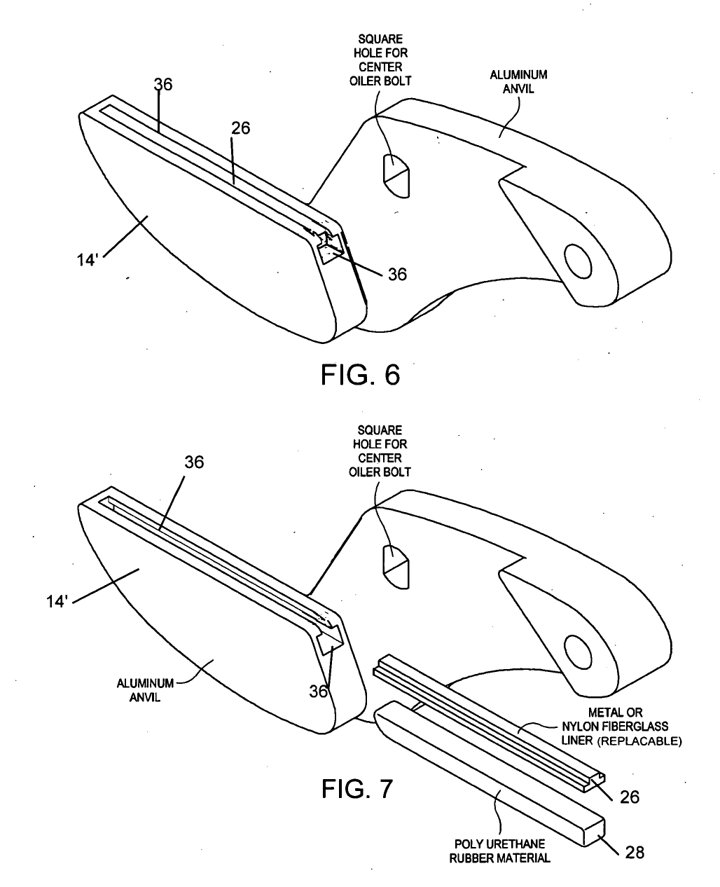

Referring to FIGS. 6 and 7, and alternative and preferred embodiment of the shock absorbing anvil is illustrated. The embodiment of FIGS. 6 and 7 does not employ the key 38 for retaining the liner 26 and shock absorber 28 in the anvil 14′. Instead, this embodiment employs the shock absorbing member 28 to provide bias to maintain base 26 in position with the anvil 14′. In assembly, shock absorbing member 28 is compressed while base 26 and shock absorber 28 are inserted into the slot 36, or, base 26 is inserted first and the compressed shock absorber is inserted afterwards, or the shock absorber is inserted first, and while the shock absorber is compressed, the base 26 is inserted. In any of the above assembly modes, when the shock absorber compression is released, the shock absorber provides sufficient bias to maintain the base 26 within the anvil.

With the above embodiments, the shock absorber 28 and base 26 can suitably be replaced as desired, to accommodate wear. A complete replacement anvil with base 26 and shock absorber 28 installed therein may be provided as replacement parts.

Accordingly, in accordance with the above description, an anvil type pruner/lopper is provided having shock absorbing capabilities, to provide a more comfortable cutting action, reduced operator fatigue and the like. The operation of the shock absorbing features results in less physical shock being transmitted through the handles of the pruner/lopper to the user's hands. Also, the compound action design of the anvil base tang provides desirable operational results.

The device promotes clean cuts, leaving no bark strings, etc., as a result of the liner 26 that operates as a cushioning device, as well as to promote ergonomic cuts. Use of the liner 26 also is less apt to dull the blade edge as compared with conventional anvil type cutting devices, but instead retains the longevity of the cutting edge. The blade edge remains ultra sharp given that it is not coming in contact with aluminum but instead with the liner which promotes clean cuts yet remains friendly with the blade coming in contact with it.

While plural embodiments of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A pruner/lopper, comprising:
a cutting blade; and
an anvil member,
wherein said cutting blade and said anvil member are in movable pivotable relation to one another, and wherein said anvil member provides shock absorbing during cutting operations.

2. The pruner/lopper according to claim 1, wherein said anvil member comprises:
a cutting base adapted to engage with said cutting blade during a cutting operation; and
a shock absorber member in relation to said cutting base for providing cushioning to said cutting base.

3. The pruner/lopper according to claim 2, wherein said anvil member has a space defined therein for receiving and maintaining said cutting base and said shock absorber member therein.

4. The pruner/lopper according to claim 4, wherein during a cutting operation, said cutting blade presses against said cutting base, which presses against and compresses said shock absorber member.

5. The pruner/lopper according to claim 3, wherein said space defined in said anvil member includes a profile and said cutting base includes a corresponding counterpart profile, and wherein said shock absorber member provides a bias for providing engagement between said profiles in absence of cutting force from said cutting blade.

6. The pruner/lopper according to claim 2, wherein said cutting base comprises a nylon fiberglass.

7. The pruner/lopper according to claim 2, wherein said cutting base comprises a metal.

8. The pruner/lopper according to claim 2, wherein said shock absorber comprises a poly urethane.

9. The pruner/lopper according to claim 2, wherein said shock absorber comprises a rubber.

10. The pruner/lopper according to claim 1, wherein said anvil member comprises aluminum.

11. A method of providing a shock absorbing pruner/lopper, comprising:
providing a cutting blade; and
providing an anvil member,
wherein said cutting blade and said anvil member are in movable pivotable relation to one another, and wherein said anvil member is provided with shock absorbing function to absorb shock during cutting operations.

12. The method according to claim 11, wherein providing said anvil member comprises:
providing a cutting base adapted to engage with said cutting blade during a cutting operation; and
providing a shock absorber member in relation to said cutting base for providing cushioning to said cutting base.

13. The method according to claim 12, further comprising providing said anvil member with a space defined therein for receiving and maintaining said cutting base and said shock absorber member therein.

14. The method according to claim 14, wherein during a cutting operation, said cutting blade presses against said cutting base, which presses against and compresses said shock absorber member.

15. The method according to claim 13, wherein providing said space defined in said anvil member includes a profile and said cutting base is provided with a corresponding counterpart profile, and wherein said shock absorber member provides a bias for providing engagement between said profiles in absence of cutting force from said cutting blade.

16. The method according to claim 12, wherein providing said cutting base comprises providing a nylon fiberglass cutting base.

17. The method according to claim 12, wherein providing said cutting base comprises providing a cutting base that is at least partially a metal.

18. The method according to claim 12, wherein providing said shock absorber comprises providing a poly urethane shock absorber.

19. The method according to claim 12, wherein providing said shock absorber comprises providing a rubber shock absorber.

20. The method according to claim 11, wherein providing said anvil member comprises providing an aluminum anvil member.
